(19) United States
(12) Patent Application Publication
(10) Pub. No.: US 2017/0045953 A1
(43) Pub. Date: Feb. 16, 2017

(54) Text Entry Using Rollover Character Row

(71) Applicant: Espial Group Inc., Ottawa (CA)

(72) Inventor: Dylan Rogers, Ottawa (CA)

(21) Appl. No.: 15/306,692

(22) PCT Filed: Apr. 25, 2014
(86) PCT No.: PCT/CA2014/050396

§ 371 Date: Oct. 25, 2016

(51) Int. Cl. G06F 3/023; H04N 21/431; H04N 21/422; G06F 17/27; H04N 21/482

(52) U.S. Cl. CPC G06F 3/0236; G06F 17/276; G06F 3/0237; H04N 21/482; H04N 21/42214; H04N 21/4312; H04N 5/4403

(57) ABSTRACT

A system and method for text entry in a user interface in a large display is provided. The improved on-screen keyboard is displayed and provides a rotating character row on the large display when a text entry window is presented. The rotating character row comprises a first plurality of characters for selection from a first subset of characters of a character set. The character set loops around in a circular fashion when a beginning or an end of the character set is reached allowing continuous rotation of the character set. Directional input is received from a remote control input device wirelessly coupled to the electronic device to rotate the character set to facilitate selection of individual characters. The user can then select character from the character set for entry into the text window.

### TECHNICAL FIELD

The present disclosure relates to virtual keyboards in graphical user interfaces for large display devices and in particular to enabling text entry into the graphical user interfaces using a directional remote control input.

### BACKGROUND

Text entry such as virtual keyboards in a user interface provided by a set-top box, or connected television, is limited by the physical form factor of typical remote controls in respect of the buttons or keys defined on the remote control. Standard remote controls provide direction navigation for moving a “focus” area on the television such as in an electronic programming guide where a desired item can then be selected. Television or set top box (STB) remote controls do not typically provide a full alphabetical keyboard due to size constraints and the need for simplicity. Therefore when text entry is required, the user must move through an on-screen keyboard and select each letter and move through the keyboard to select the next letter. The on-screen display keyboards are typically either presented as a standard keyboard layout, such as QWERTY layout, or an alphabetical keyboard of a unique configuration requiring considerable movement amongst the letters to enter text using only the navigation buttons of the remote control. Entering text, such as in a search query, can require many navigation inputs into the remote control by the user and take considerable time to navigate to letters to enter text. Existing text entry methods can be time consuming and frustrating to the user due to the amount of navigation required. In addition, traditional keyboards for text entry presented in a television type interface, particularly where the viewer is sitting a typical viewing distance from the television such as in a family room viewing environment, can require significant screen real-estate to display all the character keys of the keyboard. It is therefore desirable to provide an improved system and method of text entry with a remote control for large displays such as televisions.

### BRIEF DESCRIPTION OF THE DRAWINGS

Further features and advantages of the present disclosure will become apparent from the following detailed description, taken in combination with the appended drawings, in which:

FIG. 1 shows a representation of system for text entry on a large display;

FIG. 2 shows a representation of a display providing a text interface entry having a rotating horizontal character row on a large display;

FIG. 3 shows a representation of a display providing a text entry interface showing rotation of the rotating horizontal character row on a large display;

FIG. 4 shows a representation of a display providing a text entry interface showing a partial word entered and suggested words in the horizontal scrolling recommendation row on a large display;

FIG. 5 shows a representation of a display providing a text entry interface showing full word selection in the horizontal scrolling recommendation row on a large display;

FIG. 6 shows a method text entry on a large display; and

FIG. 7 shows an alternative method of text entry on a large display.

It will be noted that throughout the appended drawings, like features are identified by like reference numerals.

### DETAILED DESCRIPTION

In accordance with an aspect of the present disclosure there is provide a method for facilitating text entry in an input field displayed on a large display coupled to an electronic device, the method performed by a processor coupled to the large display, the method comprising: displaying a rotating character row on the large display when a text entry window is presented, the rotating character row comprising a first plurality of characters for selection from a first subset of characters of a character set, the character set loops around in a circular fashion when a beginning or an end of the character set is reached allowing continuous rotation of the character set; receiving horizontal directional input from a remote control input device wirelessly coupled to the electronic device, the remote control input device provide two dimensional input, wherein directional input rotates the character row to display a second subset of characters of the character set; receiving a selection of a character from the rotating character row; and displaying the selected character in text entry field.

In accordance with another aspect of the present disclosure there is provided a computer readable memory comprising instructions for execution by a processor, the instructions for performing the method for displaying a rotating character row on the large display when a text entry window is presented, the rotating character row comprising a first plurality of characters for selection from a first subset of characters of a character set, the character set loops around in a circular fashion when a beginning or an end of the character set is reached allowing continuous rotation of the character set; receiving directional input from a remote control input device wirelessly coupled to the electronic device, the remote control input device provide two dimensional input, wherein directional input rotates the character row to display a second subset of characters of the character set; receiving a selection of a character from the rotating character row; and displaying the selected character in text entry field.

In accordance with still yet another aspect of the present disclosure there is provided a device for providing a graphical user interface, the device comprising a processor and memory, the memory containing instructions for performing the method for displaying a rotating character row on the large display when a text entry window is presented, the rotating character row comprising a first plurality of characters for selection from a first subset of characters of a character set, the character set loops around in a circular fashion when a beginning or an end of the character set is reached allowing continuous rotation of the character set; receiving directional input from a remote control input device wirelessly coupled to the electronic device, the remote control input device provide two dimensional input, wherein directional input rotates the character row to display a second subset of characters of the character set; receiving a selection of a character from the rotating character row; and displaying the selected character in text entry field.

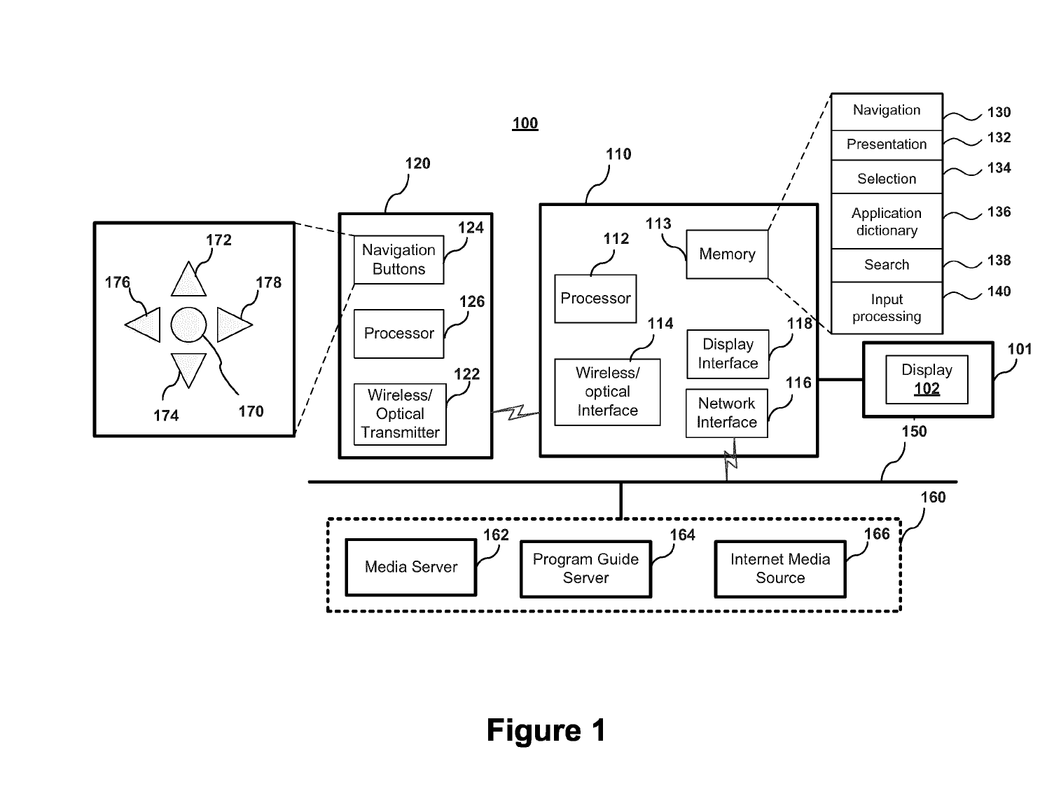

Embodiments are described below, by way of example only, with reference to FIGS. 1-7. A system and method for text entry on a large display, such as a television, is provided. The improved on-screen keyboard is displayed on a large display and provides a rotating horizontal, or vertical, character row on the large display when a text entry window is presented. The rotating horizontal character row comprises a first plurality of characters for selection from a first subset of characters of a character set. The character set loops around in a circular fashion when a beginning or an end of the character set is reached allowing continuous rotation of the character set. Horizontal directional input is received from a remote control input device wirelessly coupled to the electronic device to rotate the character set to facilitate selection of individual characters. The user can then select characters from the character set for entry into the text window. The text entry display provides a compact interface that enables easy of text entry using a remote control have directional input and removes the need for providing a typical full on-screen keyboard display while provide a quick method for entering text. The horizontal selection method enables the cursor to be kept in focus in the entry window and eliminates the cursor jumping to other on-screen elements speeding text entry. A prediction or recommendation row or display can also be provided to increase the speed of text input and provide suggestions based upon metadata associated with content being searched, user history or likely word combinations or suggestions.

FIG. 1 shows a representation of system for text entry. The interactive system 100 includes a display device 101, such as a television display, a set top box 110, a remote control 120 for operating the display device 101 via the set top box 110, and a network 150 coupling to media providers 160 (e.g., 162, 164, 166), as shown in FIG. 1. The interactive display system 100 may include an Internet Protocol Television (IPTV) system, cable TV system, satellite TV system, and/or Internet content based system. The set top box 110 is configured so that the viewer of the display device 101 can interact with a user interface presented on display 102 of television 101, such as media applications, an electronic programming guide (EPG) or interactive applications. Certain functions of the user interface may require text entry, for example a search function in which the user provides search criteria using text entry via the remote control 120. The set top box (STB) 110 (hereinafter referred to as “STB 110”) is illustrated separately from the display device 101 for illustrative purposes only. The STB 110, or a part of the STB 110, may be integrated into the display device 100 or part of a computer, mobile device, HDMI or USB device.

The STB 110 is configured to play media content provided from a plurality of media applications via the network 150. The media applications provided to the display device 101 includes, for example, but not limited to, television (e.g., digital multimedia broadcasting programming), radio, advertisement, games, audio and video on-demand, electronic programming guide (EPG), local or remotely stored content, and/or Internet-based applications. The viewer of the display device 101 may access the content by selecting a specific content source or item via the remote control 120 by using navigation buttons 124 to move through the channels, a guide, or application or media interface. A search function may also be provided to enable the user find content from one or more media sources. The buttons may be physical buttons or provided on a touch interface of the remote control 120.

The remote control 120 may contain multiple buttons each associated with one or more functions. Navigation buttons 124 (up, down, left, right), menu buttons for selecting applications, channel buttons for selecting channels of the TV programming, selection button may be provided by the remote control 120. As well appreciated by one of ordinary skill in the art that the remote control 120 may include buttons not illustrated in the drawings to provide additional functions. The buttons may be physical buttons or provided on a touch interface of a mobile device, tablet device or remote control.

The remote control 120 includes user navigation buttons 124 configured to issue commands associated with the display device 100. The navigation buttons 124 may be physical buttons on the remote or virtual buttons presented on a display screen of the remote. The remote control 120 includes a processor 126 (e.g., microprocessor) and memory (e.g., Random Access Memory (RAM), Read Only Memory (ROM), flash memory) configured to store instructions/codes/programs for processes executed on the processor 126. The processor 126 in the remote control 120 is configured to detect operation of any of the user navigation buttons 124 and/or receive signals from any of the user navigation buttons 124, generate commands for associated events, and transmit them to the STB 110 through a wireless, radio frequency, or optical interface provided by transmitter 122. The remote control can use infrared (IR), radio frequency (RF), Wi-Fi, Zigbee™, or other wireless standards to communicated with the STB 110 or display device 101. The buttons of the remote control 120 include a selection (OK/Enter/Select) key 170 and a plurality of navigation buttons 172-178. The navigation buttons 124 include direction arrow buttons including an up arrow button 172, a left arrow button 176, a right arrow button 178, and a down arrow button 174. Each arrow button may be used to move the selection of an option in the corresponding direction by sending a direction command to the STB. Although only four navigation arrow buttons are shown, a multi-directional button or multiple buttons may be provided to enable diagonal direction input and not necessarily be limited to x/y axes input. By using the navigation buttons 124, commands are provided to move a selection (e.g., highlight, cursor or mark) to the desired object within a user interface. The selection button 170 is used to send a command to select the highlighted or marked object and activate a function associated with the selected object, which will cause an operation event associated with the display device 101 by the STB 110. The selection button 170 and the navigation buttons 172-178 may be used to navigate the user interface presented on the display 102 screen by movements such as up, down, left, right. Alternatively a multi-directional input such as a touch pad, joystick or track ball may be provided for navigation input to limit navigation direction.

The media applications may be provided by a media provider 160 including, for example, but not limited to, a media server 162 for providing media content from a database and/or via Internet, a program guide provider 164, various audio/visual/Internet based devices 166 (e.g., DVD, streaming devices, handheld network devices, etc.).

The STB 110 is operatively coupled to the display device 101 and the network 150. The STB 110 includes a receiver 114, which may include a wireless or optical interface for receiving commands from the remote control 120 via infrared or radio frequency input, a network interface 116 for communication via the network 150, and a display interface 118 for output to the display 102. The transceiver in the STB 110 may include an interface for communication with any other electronic devices. The STB 110 is configured to implement bi-directional communication with the display device 101 and the network 150 and receive command from the remote control 120 to control programming and control the display device 101.

The STB 110 includes a processor 112 (e.g., microprocessor) and memory 113 (e.g., Random Access Memory (RAM), Read Only Memory (ROM), flash memory). The memory 113 in the STB 110 is configured to store instructions/codes/programs for processes executed on the processor 112 such as a navigation module 130 for processing navigation inputs from the remote control and for interacting with a user interface presented on the display 102 such as an EPG or media interface, a presentation module 132 for rendering elements of the user interface, a selection module 134 for enabling selection of objects presented in the user interface, an application dictionary 136 for providing words or phrases associated with a content source, a search module 138 for enabling the search of one or more content sources, and an input processing module 140 for processing commands received from the remote control 120 and determining interactions within the user interface. The memory 113 may also include content or media, metadata or instructions for accessing content media or metadata remote from the STB 110. The processor 112 in the STB 110 is configured to retrieve data (e.g., media content or information associated with the media content) over the network 150, and to convert the data in the form of signals provided to the display device 101. The processor 112 in the STB 110 is configured to receive and detect commands from the remote control 120 and to activate appropriate functions associated with the commands (e.g., setting the display device 101, converting media data to play it on the display device 101, transmitting media data to the display device 101).

It would be appreciated by one of ordinary skill in the art that the STB 110 may include components not shown in the drawings, for example, circuitry for converting (e.g., decoding) media content from the media providers 160 and/or operation commands from the remote control 120 to operate the display device 101.

The viewer of the display device 101, such as a television, operates the remote control 120 to generate commands to cause operation events related to the display device 101. The commands associated with the display device 101 include, for example, setting the display device 101 and associated devices (e.g., DVDs) and the network connection of the display device 101, and viewing/watching a desired program on the display screen 102.

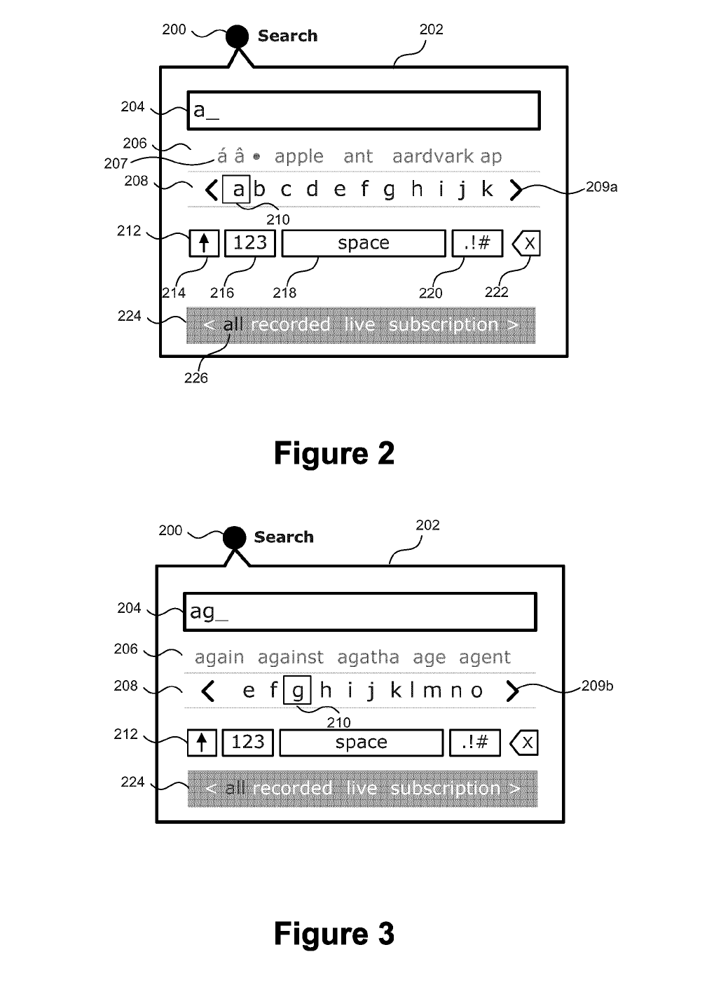

As shown in FIG. 2, text entry may be required for the user to enter information, such as in a search function, credential entry, address entry or entering configuration information. The text entry method provides a compact means of text entry as opposed to existing on screen display keyboard input methods. In a non-limiting example, a user interface element 200 is presented on the display screen 102 and is navigated by operation of the remote control 120. In this example a text entry interface is provided as part of a search 202 window. The search function may be for example to search of one or more content stores associated with the STB 110. In response to presenting the user interface in the search function 202, the text entry field 204 is presented on the display 102 screen. The presentation of the text entry interface 202 may be integrated with the entry field of positioned dynamically relative to the position of the field into which text is entered. For example the text entry interface may move relative to the position of the entry field displayed within the interface. The text entry interface 202 is generated in the STB 110 in response to the operation of the remote control 120 to select a field that requires text entry. The test entry interface 202 may appear over or under a text entry field 204 that is anywhere in the user interface 202. The user interface 200 provides a rotating horizontal character row 208 which is controlled by the horizontal directions, for example left 176 and right 178 buttons. The rotating horizontal character row 208 displays a portion of the character set 209a where the character set 209, for example the letters a to z, loops around in a circular fashion when the beginning or the end of the character set 209 is reached allowing continuous rotation of the character set 209. An individual character can be selected from the rotating character row 208 by identification of a selection indicia 210. The indicia 210 may move along the displayed portion 209a of the character set 209 based upon directional input or may be stationary such as in the middle of the display. The user is able to scroll left and right along this row of characters indefinitely. Once at the end of the character set 209 the character row 208 loops back to the beginning again. The use of horizontal entry (left/right) provide a more ordered and predictable entry method reducing wandering of focus of a typical virtual keyboard. Selecting any character places the character into the text entry field 204. By default when the text entry user interface 200 is displayed the focus will be on the first character in this row 204. Once a particular character is selected, in this example the letter ‘a’ by the user pressing the selection button 170, the letter is entered in the text entry field 204 and a recommendation row 206 is presented with suggestions based upon the letter or letters selected. The recommendation row can present suggestions from an application specific dictionary based upon metadata from associated content stores. The recommendation may be based upon most likely or common words associated with the content or may make recommendations based upon associated user preferences in possible words or characters that may be likely to be inputted, or predict words based upon past word entry or associations.

The recommendation row 206 presents alternate characters and words or phrases based upon the selected character from an application specific dictionary associated with the application. The dictionary can be derived from metadata associated with content in a content store and updates as the user places focus on (or selects) any character in the rotating horizontal character row 208. Each dictionary has a unique identifier which is used to determine when that specific dictionary should be used for recommendation or prediction. For example, this identifier may associate an application-specific dictionary with one content store, while an alternative content store may use another application-specific dictionary with a different identifier.

The recommendation row 206 does not loop, the left side of the recommendation row 206 can identify any diacritical marks 207 associated with the letter in focus in the rotating horizontal character row 208, for example if an “a” is in focus in the rotating horizontal character row 208 then the recommendation row 206 will display “å, à, á . . . ” etc if there is content having diacritical marks. The right side of the recommendation row 206 display predicted words. When focus is moved from the rotating horizontal character row 208 to the recommendation row 206, then items in the recommendation row 206 do not change.

The right side of the recommendation row 206 displays predicted words or phrases based on the first few characters in the text entry field as well as the character in focus in the horizontal character row 208. The words or phrases can be presented in the order of most likely on the left, to less likely as the user moves to the right. As soon as the user moves back down to the rotating horizontal character row 206 and moves left or right the recommendation row 208 updates again with the position between the diacritical marks and words or phrases within view. The application specific dictionary may be derived from for example metadata associated with a movie database associated with available content source. When a word in the recommendation row 206 is selected, it will enter the selected diacritical mark or complete the word in the text entry field 204. Focus then moves back down to the last letter in focus on the rotating horizontal character row 208.

An alternate input row 212 provides additional input buttons to enable changes to the character set or common editing or entry functions. For example a shift key 214 can be provided which has three states, the 1^{st} state is for lower case characters, the 2^{nd} state is for upper case characters but only one at a time (toggles back to 1^{st} state after a character is selected), and the 3^{rd} state is a locked shift which allows user to press multiple upper case characters without losing the state. A character set selection button 216 may be provided which can toggle between character sets such as alphabetical or numerical character sets. When the character set selection button 216 is pressed, the button toggles to an “a b c” state indicating that pressing it again returns the user to the alphabet. A space bar 218 produces a space character. A special character button 220 can be provided to select for example symbols or an alternate character set. Pressing the special character button 220 toggles the rotating horizontal character row 206 to special characters. Once a special character is selected, the rotating horizontal character row 206 toggles back to the alphabet. When pressed the button toggles to an “a b c” button indicating that when pressed it returns the user to the alphabet. Note, if this button is pressed at the same time as the “1 2 3” button is in the “a b c” state, then the “1 2 3” button will toggle back to “a b c”. Alternate input row 212 changes based on context, for example if entering text it would include the number or punctuation character buttons.

A delete button 222 can be provided to remove one letter from the text entry field 204. A content selection row 224 may also be provided for selecting the type of content to be searched and a related application specific dictionary or a filter to the selected application specific dictionary. The content may be limited to the type of program, location of programs, type of program, genre, or metadata associated with content which may be used to select the application specific dictionary for example all, recorded, live, subscribed, on-demand, etc. Alternatively the application specific dictionary may be determined based upon the presentation of the text entry field in relation to a certain function within the user interface, for example searching or web browsing.

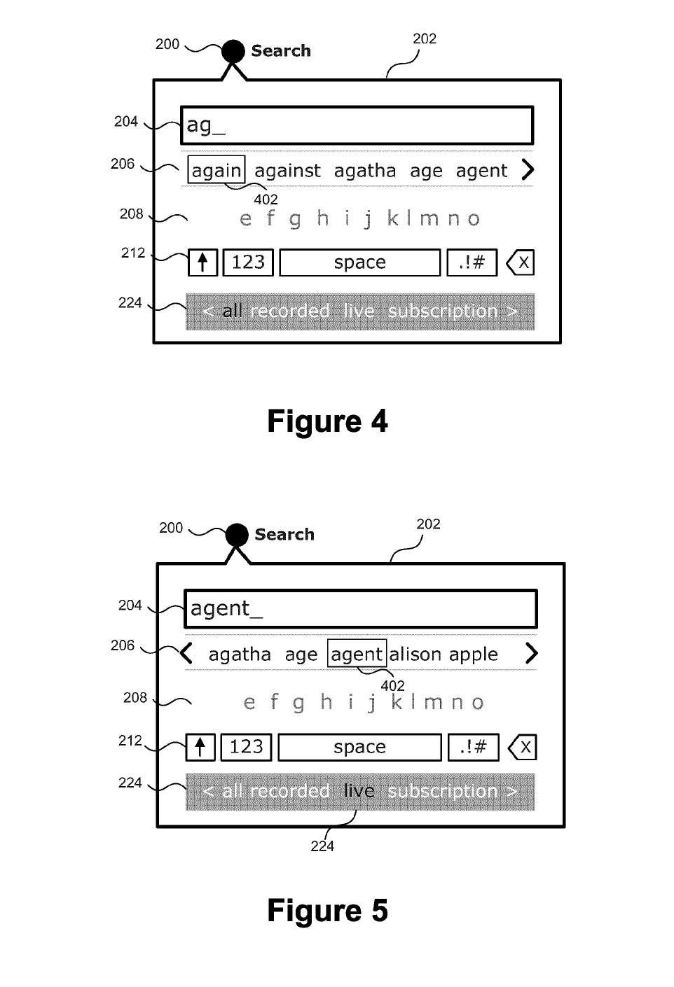

Referring to FIG. 3, a second character ‘g’ 210 has been selected from the rotating character row 208 by receiving directional input to the right by button presses 178 and a selection button press 170 from the remote control 120. The character ‘g’ is placed in text entry field 204. Based upon the updated entry the recommendation row 206 is updated to show a new selection of possible words or phrases. Referring to FIG. 4, an up direction input by up button 172 is received placing focus on the recommendation row 206; the user may then navigate the recommendation row 206 by an identifier 402 to select a word for entry into the text entry field 204. The presentation of the recommendation row 206 may be alphabetical or based upon most common or likely words for entry. Referring to FIG. 5, the user may move along the recommendation row 206 to select different words for entry for example selecting the word ‘agent’ with the identifier 402. However the recommendation row 206 may change based upon a change to the content selection row 224 changing to a different selection and therefore a different application specific dictionary.

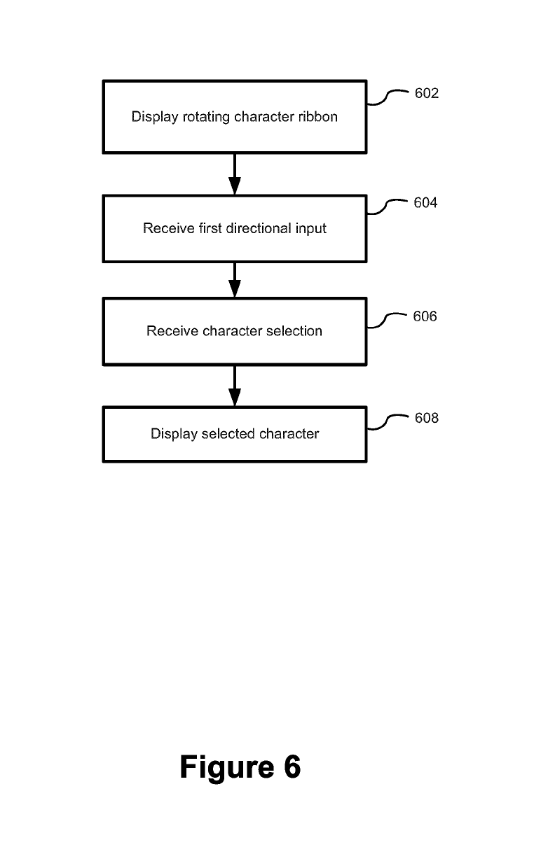

FIG. 6 show a method for facilitating text entry in an input field displayed on a large display coupled to an electronic device. The method is performed by a processor executing instructions retrieved from a memory. The processor is coupled to the large display either by the processor integrated with the display or provided by a media device having display output capability such as set top box, streaming stick, or media playback device. A rotating horizontal character row on the large display when a text entry window is presented is displayed on the display (602). The rotating horizontal character row comprises a first plurality of characters for selection from a first subset of characters of a character set, the character set loops around in a circular fashion when a beginning or an end of the character set is reached allowing continuous rotation of the character set. Horizontal directional input is received from a remote control input device wirelessly coupled to the electronic device (604). The remote control input device provide two dimensional input, wherein horizontal directional input rotates the horizontal character row to display a second subset of characters of the character set. A selection of a character from the rotating horizontal character row is received (606) and the selected character is displayed in the text entry field (608).

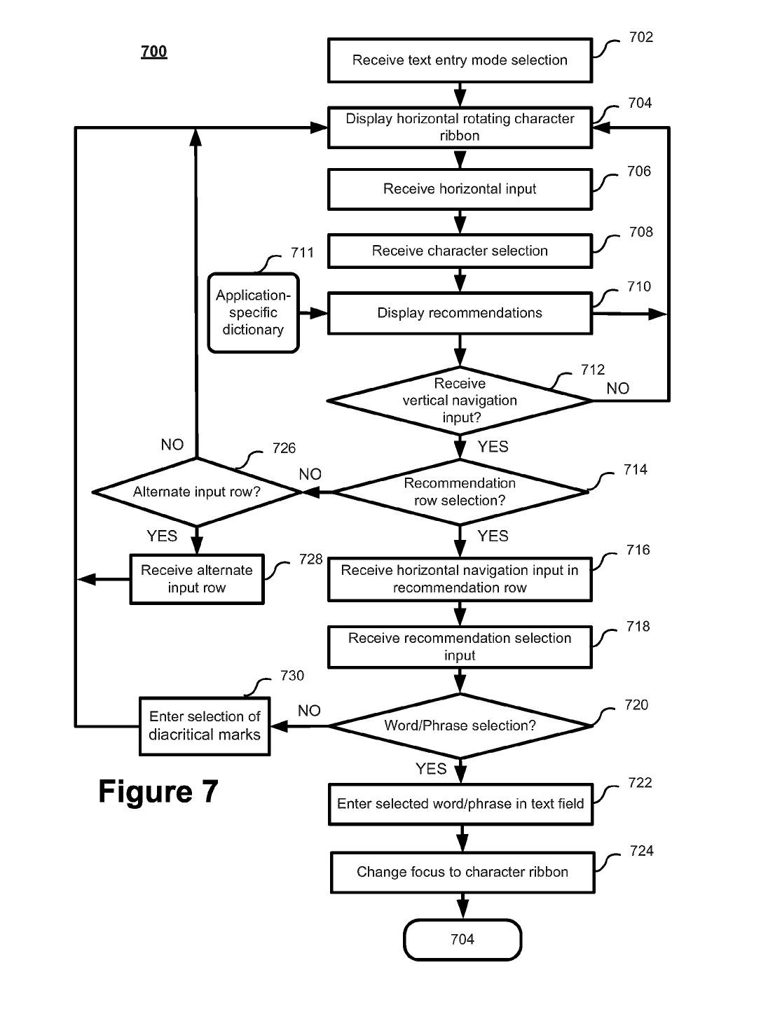

FIG. 7 shows an alternative method for television text entry. The method 700 commences with receiving a text entry mode selection (702). The text entry mode selection may be initiated by the user selecting a function, such as a search function, or when selecting a field that requires text input. In response a text entry interface is presented displaying a rotating horizontal character row (704). Navigation input is received from the remote control to select characters from the rotating horizontal character row (706). Character selection is then received (708) by the selection key 170 on the remote control 120. In response to the character selections word or phrase recommendations or predictiosn are displayed from the application-specific dictionary (710). The selection of the words is dependent on the application and the associated dictionary (711). As more characters are selected by the user the recommendation suggestions may be updated. When vertical navigation input is received (YES at 712), it is determined if vertical navigation movement is to the recommendation row (YES at 714), horizontal movement within the recommendation row is then received (716). A recommendation selection input is received (718) from the recommendation row. If diacritical marks were presented and a selection of one of the marks is received (NO at 720) they are entered in the text entry field (730) and character selection in the rotating horizontal character row continues. If a word or phrase is selected (YES at 720) the word of phrase is entered in the text entry field (722). The focus is then changed back to the character ribbon (724) so that further input can be received (704) or the text entry confirmed. If vertical navigation input is not received (NO at 712) the text entry continues until the operation is cancelled, entry selection is confirmed, or movement to another row occurs. When vertical navigation input does occur, but it is not to the recommendation row (NO at 714), selection of the alternate input row may be performed (YES at 726) and one of the alternate row input button selected (728), and the method may then revert back to character input. If the alternate input row is not selected (NO at 726) the focus is on another row. Additionally or alternatively vertical navigation can occur at any time and change highlighting of a row or input field during the method. Although the method provides for linear movement between displayed rows the user may not necessarily move directly between the rotating horizontal character ribbon and the recommendation row but may perform other action in-between. Additional rows may be presented for additional input functions such as selection of the content to be searched an application specific dictionary. Similarly the functions provided by the alternate input row may be required or may be performed directly by buttons on the remote control or presented in different positions within the user interface.

Although the display elements of the text interface have been shown in a particular layout it should be understood that rows or elements in the interface may be modified or positioned in different orientations horizontally or vertically to still achieve the desired function. For example the character row may be presented vertically rather than horizontally, where the direction input up/down vertical navigation keys would be used rather than the left/right horizontal navigation keys. Modifications to the direction of entry or positions of the elements are within the scope of the present disclosure.

Each element in the embodiments of the present disclosure may be implemented as hardware, software/program in a carrier, or any combination thereof. Software codes, either in its entirety or a part thereof, may be stored in a computer readable medium or memory (e.g., as a ROM, for example a non-volatile memory such as flash memory, CD ROM, DVD ROM, Blu-Ray™, a semiconductor ROM, USB, or a magnetic recording medium, for example a hard disk). The program may be in the form of source code, object code, a code intermediate source and object code such as partially compiled form, or in any other form.

It would be appreciated by one of ordinary skill in the art that the system and components shown in FIGS. 1-7 may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

1. A method for facilitating text entry in an input field displayed on a large display coupled to an electronic device, the method performed by a processor coupled to the large display, the method comprising:
displaying a horizontal rotating character row on the large display when a text entry field is presented, the horizontal rotating character row comprising a first plurality of characters for selection from a first subset of characters of a character set, the character set loops around in a circular fashion when a beginning or an end of the character set is reached allowing continuous rotation of the character set;
receiving a first horizontal directional input from a remote control input device wirelessly coupled to the electronic device, wherein first horizontal directional input rotates the character row to display a second subset of characters of the character set in a horizontal direction associated with the first horizontal directional input;
receiving a selection of a character highlighted from the rotating character row; and
displaying the selected character in the text entry field on the large display.

2. The method of claim 1 further comprising:
determining words or phrases from an application specific dictionary from one or more received characters in the text entry field;
displaying a recommendation row presenting on the large display, the recommendation row comprising at least a subset of the determined words or phrases;
receiving second vertical directional input, from the remote control input device coupled to the electronic device, the second vertical directional input directing focus to the recommendation row;
receiving first horizontal directional input from the remote control input device wherein first horizontal directional input rotates the recommendation row to display a second subset of determined word or phrases; and
receiving a selection of a word or phrase presented in the recommendation row, the word or phrase being placed in the text entry field.

3. The method of claim 2 wherein the application specific dictionary is created from metadata associated with one or more content stores, the metadata for describing the content in the one or more content stores.

4. The method of claim 2 wherein a unique identifier is used for determining an application specific dictionary from a plurality of available application-specific dictionaries that should be used for determining words or phrases for display.

5. The method of claim 3 wherein the recommendation row further provides diacritical marks character suggestions based on a selected character input.

6. The method of claim 3 wherein the recommendation row is presented above or below the rotating character row.

7. (canceled)

8. (canceled)

9. The method of claim 1 wherein the character set selection is one or more of a number character set selection, shift key, a symbol character set selection, an alphabet character set selection, and a delete key.

10. (canceled)

11. (canceled)

12. The method of claim 1 wherein a selection identifier is displayed, the selection identifier presenting a plurality of selections associated with one or more content stores.

13. The method of claim 1 further comprising displaying metadata associated with one or more content items based on a word or phrase selected in the input field.

14-18. (canceled)

19. A non-transitory memory containing instructions for facilitating text entry in an input field displayed on a large display coupled to an electronic device, the instructions when executed by a processor coupled to the large display, perform:
displaying a horizontal rotating character row on the large display when a text entry field is presented, the horizontal rotating character row comprising a first plurality of characters for selection from a first subset of characters of a character set, the character set loops around in a circular fashion when a beginning or an end of the character set is reached allowing continuous rotation of the character set;
receiving first horizontal directional input from a remote control input device wirelessly coupled to the electronic device, wherein first horizontal directional input rotates the character row to display a second subset of characters of the character set in a horizontal direction associated with the first horizontal directional input;
receiving a selection of a character highlighted from the rotating character row; and
displaying the selected character in the text entry field on the large display.

20. A device for providing a user interface on a large display device, the device comprising:
a processor;
a memory containing instructions for configuring the process to:
display a horizontal rotating character row on the large display when a text entry field is presented, the horizontal rotating character row comprising a first plurality of characters for selection from a first subset of characters of a character set, the character set loops around in a circular fashion when a beginning or an end of the character set is reached allowing continuous rotation of the character set;
receive a first horizontal directional input from a remote control input device wirelessly coupled to the electronic device, wherein first horizontal directional input rotates the character row to display a second subset of characters of the character set in a horizontal direction associated with the first horizontal directional input;
receive a selection of a character highlighted from the rotating character row; and
display the selected character in the text entry field on the large display.

21. The device of claim 20 further configured to:
determine words or phrases from an application specific dictionary from one or more received characters in the text entry field;
display a recommendation row presenting on the large display, the recommendation row comprising at least a subset of the determined words or phrases;
receive second vertical directional input, from the remote control input device coupled to the electronic device, the second vertical directional input directing focus to the recommendation row;
receive first horizontal directional input from the remote control input device wherein first horizontal directional input rotates the recommendation row to display a second subset of determined word or phrases; and
receive a selection of a word or phrase presented in the recommendation row, the word or phrase being placed in the text entry field.

22. The device of claim 21 wherein the application specific dictionary is created from metadata associated with one or more content stores, the metadata for describing the content in the one or more content stores.

23. The device of claim 21 wherein a unique identifier is used for determining an application specific dictionary from a plurality of available application-specific dictionaries that should be used for determining words or phrases for display.

24. The device of claim 23 wherein the recommendation row further provides diacritical marks character suggestions based on a selected character input.

25. The device of claim 23 wherein the recommendation row is presented above or below the rotating character row.

26. The device of claim 20 wherein the character set selection is one or more of a number character set selection, shift key, a symbol character set selection, an alphabet character set selection, and a delete key.

27. The device of claim 20 wherein a selection identifier is displayed, the selection identifier presenting a plurality of selections associated with one or more content stores.

28. The device of claim 20 wherein the processor is further configured to display metadata associated with one or more content items based on a word or phrase selected in the input field.
